(19) United States
(12) Patent Application Publication
(10) Pub. No.: US 2017/0171082 A1
(43) Pub. Date: Jun. 15, 2017

(54) METHOD AND ELECTRONIC DEVICE FOR UPDATING CLIENT DATA

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Dan JIANG, Beijing (CN)

(21) Appl. No.: 15/243,781

(22) Filed: Aug. 22, 2016

Related U.S. Application Data
(63) Continuation of application No. PCT/CN2016/088687, filed on Jul. 5, 2016.

(30) Foreign Application Priority Data
Dec. 15, 2015 (CN) 201510937920.0

(51) Int. Cl. H04L 12/801; H04L 12/721; H04L 12/26

(52) U.S. Cl. CPC H04L 47/12; H04L 43/16; H04L 45/70; H04L 67/42

(57) ABSTRACT

Embodiments of this application disclose a method and electronic device for updating client data, includes: acquiring a request transmission-restricting time returned by an access server based on a data update request; and controlling a time for subsequently transmitting the data update request to the access server, based on the request transmission-restricting time.

### CROSS-REFERENCES TO RELATED APPLICATIONS

The present application is a continuation of International Application No. PCT/CN2016/088687, filed on Jul. 5, 2016, which is based upon and claims priority to Chinese Patent Application No. 2015109379200.0, filed on Dec. 15, 2015, the entire contents of which are incorporated herein by reference.

### TECHNICAL FIELD

The present application relates to Internet application technology, for example, to a method and an electronic device for updating client data.

### BACKGROUND

With the development of technology, an intelligent terminal has more and more, stronger and stronger functions, and the respective various applications (Application, APP), used as clients, are installed on the intelligent terminal. The client of the application usually needs to interchange information with the respective server, that is, the client transmits an API request to the server via the application programming interface (Application Programming Interface, API) to acquire a request result from the server, parse data in the request result, and update data in the client. For example, a yellow page application needs to timely acquire various contact data of an enterprise or an individual from the server, and update data in the client of the yellow pages application in real time.

After the client sends an API request to the server and obtains the request result, if the data in the server has not yet been updated, then data in the request result is the same with the data obtained in the previous request, in this case, the request not only consumes terminal throughput, but also increases the burden on the server.

Accordingly, the technical solutions provided in the related art is that, after the client sends an API request to the server, the server judges whether data in the current API request and the previous API request change, if no change occurs, then the repeated data will not be returned to the client.

In the process of implementing this application, the inventor finds at least the following problems in the prior art: in the technical solutions provided in the related art, the amount of data transmitted over a network when the server returns data to the client is saved, terminal throughput consumption is reduced, and the speed of the client for the API request is improved, however, the client still needs to sends the API request to the server frequently, so that the times of network transmission are not reduced, and the burden on the server has not been relieved.

### SUMMARY

Embodiments of this application provide a method for updating client data, another method for updating client data and an electronic device, so as to reduce the number of network transmissions, and lessen the burden on the server.

In a first aspect, embodiments of this application provide a method for updating client data, which includes:

acquiring a request transmission-restricting time returned by an access server based on a data update request; and

controlling a time for subsequently transmitting the data update request to the access server, based on the request transmission-restricting time.

In a second aspect, embodiments of this application also provide another method for updating client data, which includes:

receiving a data update request transmitted by a client;

determining a request transmission-restricting time of the client, based on an update rule of data requested by the data update request; and

returning the request transmission-restricting time to the client, so that the client can control a consequent time for transmitting the data update request.

In a third aspect, embodiments of this application also provide an electronic device for implementing a method for updating client data, including at least one processor and a memory communicably connected with the at least one processor for storing instructions executable by the at least one processor, wherein execution of the instructions by the at least one processor causes the at least one processor to:

acquire a request transmission-restricting time returned by an access server based on a data update request; and

control a time for subsequently transmitting the data update request to the access server, based on the request transmission-restricting time.

### BRIEF DESCRIPTION OF DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for updating client data according to some embodiments of this application;

FIG. 2 is a flowchart of a method for updating client data according to a some embodiments of this application;

FIG. 3 is a flowchart of a method for updating client data according to a some embodiments of this application;

FIG. 4 is a flowchart of a method for updating client data according to a some embodiments of this application;

FIG. 5A is a first schematic diagram of a client for implementing a method for updating client data according to some embodiments of this application;

FIG. 5B is a second schematic diagram of a client for implementing a method for updating client data according to some embodiments of this application;

FIG. 6A is a first schematic diagram of a server for implementing a method for updating client data according to some embodiments of this application;

FIG. 6B is a second schematic diagram of a server for implementing a method for updating client data according to some embodiments of this application;

FIG. 7 is a hardware structural schematic diagram of a device for performing the method for updating client data according to some embodiments of this application; and

FIG. 8 is a hardware structural schematic diagram of a device for performing the method for updating client data according to some embodiments of this application.

### DETAILED DESCRIPTION

In order to make the purposes, technical solutions and advantages of the embodiments of this application clearer, the technical solutions in the embodiments of this application will be clearly and completely described hereinafter according to the accompanying drawings of this application. Obviously, those embodiments described here are not all but only a part of embodiments of this application.

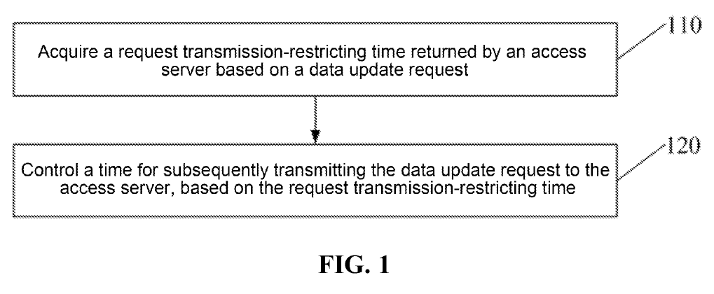

As shown in FIG. 1, which is a flowchart of a method for updating client data according to some embodiments of this application, technical solutions in this embodiment is applicable to a case that the client controls the time for transmitting the data update request to the access server, so as to intercept the unnecessary data update request, and the method is implemented by a client and the client is configured in an intelligent terminal.

The method for updating client data according to this embodiment includes steps as follows:

In S110, a request transmission-restricting time returned by an access server is acquired based on a data update request.

As described above, the client transmits a data update request, the access server is used to receive a data update request transmitted by a client and provide a request transmission-restricting time to the client according to the data update request. The request transmission-restricting time refers to a time for restricting the client to transmit the subsequent data update request determined by the access server, and the client controls the subsequent transmission of the data update request based on the request transmission-restricting time. When the access server receives different data update requests transmitted by the client, the request transmission-restricting times corresponding to different data update requests may be different. The subsequent data update request refers to the data update request transmitted after the data update request in this step.

In the above operations, after transmitting the data update request, the client acquires the request transmission-restricting time returned by the access server based on the data update request, so as to take the request transmission-restricting time as a basis for controlling a time for subsequently transmitting the data update request.

In S120, a time for subsequently transmitting the data update request to the access server is controlled, based on the request transmission-restricting time.

As described above, the client acquires the request transmission-restricting time, it is known that the request transmission-restricting time refers to a time for restricting the client to transmit the subsequent data update request determined by the access server, then the client can determine that the data update request with a transmission time not exceeding the request transmission-restricting time is an unnecessary data update request of the client. At this time, the client controls not to transmit the data update request generated within the request transmission-restricting time, that is, controls the time for subsequently transmitting the data update request to the access server to be greater than the request transmission-restricting time, thereby, the client can intercept an unnecessary data update request and control a time for subsequently transmitting the data update request, so that the number of network transmissions can be reduced.

When the time detected by the client is greater than the request transmission-restricting time, the client generates a data update request, the client transmits the data update request to an access server, and acquires a request transmission-restricting time returned by the access server based on the data update request, and then controls a time for subsequently transmitting the data update request to the access server, based on a new request transmission-restricting time. Therefore, steps S110 to S120 are performed in a loop, the client controls a time for subsequently transmitting the data update request to the access server, based on the request transmission-restricting time, and intercepts an unnecessary data update request of the client. Alternatively, the acquired request transmission-restricting time also can be applicable to restricting transmission of multiple data update requests. For example, the currently acquired request transmission-restricting time can be used to control transmission of requests within a subsequent time or set times.

By adopting the method for updating client data according to the first embodiment of this application, the client acquires a request transmission-restricting time returned by an access server based on a data update request, and controls a time for subsequently transmitting the data update request to the access server, based on the request transmission-restricting time. In the embodiments of this application, the client controls a time for transmitting the data update request through the request transmission-restricting time, and intercepts an unnecessary data update request based on the request transmission-restricting time, so that the number of network transmissions can be reduced, the burden on the access server can be relieved, and transmission data amount and network overhead can be saved.

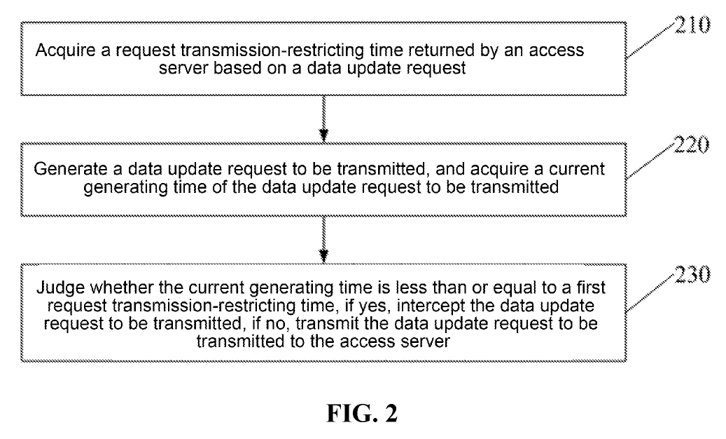

As shown in FIG. 2, which is a flowchart of a method for updating client data according to some embodiments of this application, technical solutions in this embodiment is applicable to a case that the client controls the time for transmitting the data update request to the access server, so as to intercept the unnecessary data update request, and the method is implemented by a client and the client is configured in an intelligent terminal.

The method for updating client data according to this embodiment includes steps as follows:

In S210, a request transmission-restricting time returned by an access server is acquired based on a data update request.

In the above operations, the request transmission-restricting time is a first request transmission-restricting time, which is a time point.

In S220, a data update request to be transmitted is generated, and a current generating time of the data update request to be transmitted is acquired.

As described above, the client generates the data update request to be transmitted based on the update instruction input by the user, and meanwhile acquires the current generating time of the data update request to be transmitted. The current generating time serves as a comparative factor to compare with the first request transmission-restricting time, and thus the client judges whether to transmit it to the access server. Generating the data update request based on the update instruction of the user can reduce network overhead, if the network overhead is not taken into account, the client in this application also can actively generate the update request regularly or according to a rule.

In S230, whether the current generating time is less than or equal to a first request transmission-restricting time is judged, the data update request to be transmitted is intercepted if the current generating time is less than or equal to the first request transmission-restricting time, or the data update request to be transmitted to the access server is transmitted if the current generating time is greater than the first request transmission-restricting time.

As described above, it is known that the first request transmission-restricting time is a moment defined by the access server, which substantially is a next data update time of the access server, after the previous data update. It can be seen that the access server will not update the data requested by the client prior to the first request transmission-restricting time, and the client doesn't need to transmit the data update request, that is, the client intercepts the data update request to be transmitted when it is determined that the current generating time is less than or equal to the first request transmission-restricting time. After the first request transmission-restricting time, the access server may update the data requested by the client, and the client may transmit the data update request, that is, the client controls transmission of the data update request to be transmitted when it is determined that the current generating time is greater than the first request transmission-restricting time. Therefore, the client controls a time for subsequently transmitting the data update request to the access server, based on the first request transmission-restricting time. Steps S210 to S230 are performed in a loop, the client controls a time for subsequently transmitting the data update request, based on the request transmission-restricting time previously returned by the access server, and intercepts an unnecessary data update request. Optionally, the client can transmit the intercepted data update request to the access server, upon arrival of the moment of the first request transmission-restricting time.

By adopting the method for updating client data according to the second embodiment of this application, the client controls the data update request transmitted to the access server to generate after the first request transmission-restricting time, by comparing the first request transmission-restricting time and the generating time of the data update request to be transmitted, and intercepts the data update request generated before the first request transmission-restricting time, so that the number of network transmissions can be reduced, the burden on the access server can be relieved, and transmission data amount and network overhead can be saved.

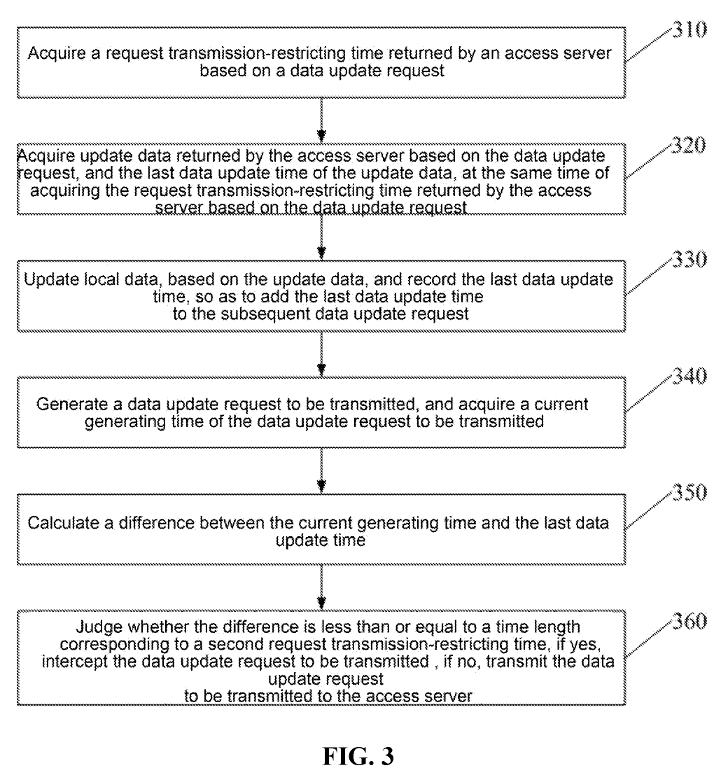

As shown in FIG. 3, which is a flowchart of a method for updating client data according to some embodiments of this application, technical solutions in this embodiment is applicable to a case that the client controls the time for transmitting the data update request to the access server, so as to intercept the unnecessary data update request, and the method is implemented by a client and the client is configured in an intelligent terminal.

The method for updating client data according to this embodiment includes steps as follows:

In S310, a request transmission-restricting time returned by an access server is acquired based on a data update request.

In the above operations, the request transmission-restricting time is a second request transmission-restricting time, which is a time period.

In S320, update data returned by the access server based on the data update request, and the last data update time of the update data are acquired, at the same time of acquiring the request transmission-restricting time returned by the access server based on the data update request.

As described above, the update data returned by the access server to the client is a content requested by the client and the last data update time of the update data. Here, the last data update time refers to the latest update time before the return time of the update data in the access server. Here, the last data update time returned by the access server can be in a format of Last-Modified: Tue, 20 Oct. 2015 18:00:56 GMT.

S330, update local data, based on the update data, and record the last data update time, so as to add the last data update time to the subsequent data update request.

As described above, the client parses the acquired update data and then displays it in the page, so as to achieve a local data update of the client. Subsequently, the client records and buffers the parsed update data and the last data update time, adds the last data update time to the subsequent data update request, for judgment by the access server. Here, the last data update time added to the subsequent data update request can be in a format of If-Modified-Since: Tue, 20 Oct. 2015 18:00:56 GMT.

In S340, a data update request to be transmitted is generated, and a current generating time of the data update request to be transmitted is acquired.

In S350, a difference between the current generating time and the last data update time is calculated.

As described above, the access server returns the last data update time of the previous update data, then the client calculates a difference between the current generating time of the data update request to be transmitted and the last data update time, and the difference is a time period from the current generating time to the last data update time.

In S360, whether the difference is less than or equal to a time period corresponding to a second request transmission-restricting time is judged, the data update request to be transmitted is intercepted if the difference is less than or equal to the time period corresponding to the second request transmission-restricting time, or the data update request to be transmitted to the access server is transmitted if the difference is greater than the time period corresponding to the second request transmission-restricting time.

As described above, it is known that the second request transmission-restricting time is a time period defined by the access server, which substantially is a time period between the last data update time and a next data update time returned by the access server, and it can be seen that the access server will not update the data requested by the client within the time period, and the access server will update the data requested by the client when the time period is exceeded. When the client determines that the difference is less than or equal to a time period corresponding to the second request transmission-restricting time, the client intercepts the data update request to be transmitted, when the client determines that the difference is greater than the time period corresponding to the second request transmission-restricting time, the client transmits the data update request to be transmitted to the access server. Steps S310 to S360 are performed in a loop, the client controls a time for subsequently transmitting the data update request, based on the request transmission-restricting time previously returned by the access server, and intercepts an unnecessary data update request of the client.

In this embodiment, the last data update time also can be a time for updating the data returned by the access server, then the time period is a time period from the data update time returned by the access server to a next data update time.

By adopting the method for updating client data according to the third embodiment of this application, the client calculates a difference between the last data update time and the current generating time of the data update request to be transmitted, and compares it with the second request transmission-restricting time, so as to control the transmission time of the data update request transmitted to the access server, and intercept the data update request generated within the second request transmission-restricting time, so that the number of network transmissions can be reduced, the burden on the access server can be lessened, and transmission data amount and network overhead can be saved.

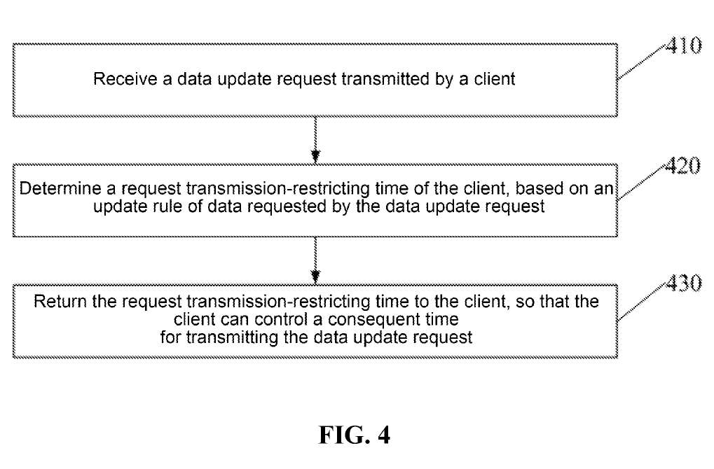

As shown in FIG. 4, which is a flowchart of a method for updating client data according to some embodiments of this application, technical solutions in this embodiment is applicable to a case that an access server relieve the burden on the access server by setting the transmission-restricting time transmitted to the client, and the method can be implemented by the access server. Particularly, the client is the one for performing the method for updating client data according to any of the above-described embodiments, and configured in an intelligent terminal, and the access server is the one for interacting with the client according to any of the above-described embodiments.

The method for updating client data according to this embodiment includes steps as follows:

In S410, a data update request transmitted by a client is received.

As described above, there is no file with a header of If-Modified-Since in the data update request firstly transmitted by the client to the access server, and the access server returns corresponding data based on the data update request. There is a file with a header of If-Modified-Since in the data update request subsequently transmitted by the client, and the access server judges whether there is an update in the content requested by the client based on the time in the file, if yes, then data requested by the client is returned, if no, then data requested by the client is not returned.

In S420, a request transmission-restricting time of the client is determined, based on an update rule of data requested by the data update request.

As described above, the access server usually needs to pull the data requested by the client from a service server, the rule for pulling the data from the service server by the access server, i.e., the update rule, is usually set to pull the data from the service server every X seconds, wherein, the value of X can be set by a managing user of the access server, and then the access server determines not to update the data within X seconds after the previous data pulling, based on the update rule. Correspondingly, the access server determines the request transmission-restricting time of the client based on the update rule, and relieves the burden on the access server by reducing the number of transmitting requests by the client. The data update rule is used to make the access server to estimate or determine the next data update time, and includes, but is not limited to, the update rule in this embodiment.

In S430, the request transmission-restricting time to the client is returned, so that the client can control a consequent time for transmitting the data update request.

As described above, after the access server returns the request transmission-restricting time to the client, the client controls the time for subsequently transmitting the data update request to the access server, based on the request transmission-restricting time, intercepts an unnecessary data update request, and reduces the number of transmitting requests to the server by the client.

When returning the request transmission-restricting time, the access server also can return other files to the client, such as a file and a status code tagged with a Last-Modified attribute, if it is determined that the requested data has been updated, contents requested by the client also can be returned to the client.

On the basis of the above technical solutions, in step 420, the request transmission-restricting time of the client can be determined in the following manners: a next update time for acquiring data to a service server for providing the requested data is determined, based on data requested by the data update request, so as to determine the first request transmission-restricting time. As described above, the access server pulls the data from the service server in certain rules, such as a timing rule or other rules, therefore, the next pulling time for pulling the requested data by the access server to the service server is known, the pulling time is the next update time of the requested data, here, the next update time is determined by the access server as the first request transmission-restricting time and returned to the client, and the client performs corresponding operations and control on it.

On the basis of the above technical solutions, in step 420, the request transmission-restricting time of the client can be determined in the following manners: a next update time for acquiring data to a service server for providing the requested data is determined, based on data requested by the data update request; and a second request transmission-restricting time is determined, based on a difference between the next data update time and the last data update time. As described above, the last data update time can be the last time for updating the data, or can be the current time for acquiring the data by the access server and returned by the access server. The access server can determine a next data update time or acquire a next data update time from a service server, based on the update rule, then the difference between the next data update time and the last data update time is the second request transmission-restricting time.

By adopting the method for updating client data according to the embodiments of this application, the access server determines the request transmission-restricting time of the client based on the update rule, and returns to the client, so that the client can control the time for subsequently transmitting the data update request, based on the request transmission-restricting rule, and intercept an unnecessary data update request, the number of processing requests by the access server can be reduced, the burden on the access server can be lessened, and transmission data amount also can be saved.

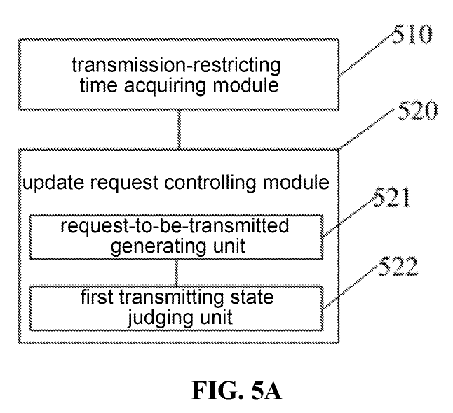

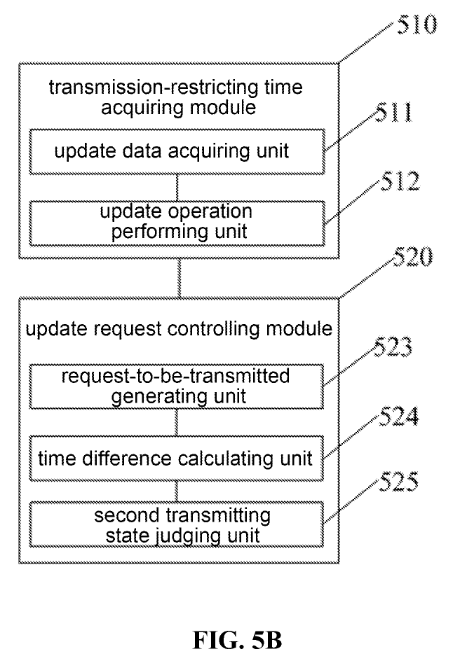

As shown in FIG. 5A, which is a first schematic diagram of a client for implementing a method for updating client data according to some embodiments of this application, technical solutions in this embodiment is applicable to a case that the client controls the time for transmitting the data update request to the access server, so as to intercept the unnecessary data update request. The client is used to perform the method for updating client data according to any of the above-described embodiments, and configured in an intelligent terminal, and the access server is the one for updating client data according to any of the above-described embodiments.

The client for implementing the method for updating client data according to this embodiment includes: a transmission-restricting time acquiring module 510 and an update request controlling module 520.

Particularly, the transmission-restricting time acquiring module 510 is configured to acquire a request transmission-restricting time returned by an access server based on a data update request; and the update request controlling module 520 is configured to control a time for subsequently transmitting the data update request to the access server, based on the request transmission-restricting time.

Optionally, the update request controlling module 520 includes: a request-to-be-transmitted generating unit 521 and a first transmitting state judging unit 522. Particularly, the request-to-be-transmitted generating unit 521 is configured to generate a data update request to be transmitted, and acquire a current generating time of the data update request to be transmitted; the first transmitting state judging unit 522 is configured to judge whether the current generating time is less than or equal to a first request transmission-restricting time, intercept the data update request to be transmitted, if the current generating time is less than or equal to the first request transmission-restricting time, or transmit the data update request to be transmitted to the access server, if the current generating time is greater than the first request transmission-restricting time.

In this embodiment, take the yellow pages application on the intelligent terminal as an example, the client needs to acquire contact data of an enterprise or an individual from the access server, and update data in the client. Here, the client accesses the server adopting a hypertext transfer protocol (Hyper Text Transfer Protocol, HTTP) request via an API, which is referred to as an API request for short. The process is as follows:

When the client firstly transmits an API request, a return status code of the access server is 200, the return content is the update data, a Last-Modified (last modified) attribute tags the time when the file is last modified in the access server in a time format of Last-Modified: Tue, 20 Oct. 2015 18:00:56 GMT, and a first request transmission-restricting time is returned, which identifies that data regarding to the same API in the access server doesn't change, prior to this time.

The client parses and displays a page after the update data is received, and also buffers the parsed update data, the Last-Modified and the first request transmission-restricting time together.

When the client is ready to transmit the API request at time T3, the client judges whether the current generating time T3 requested by the API exceeds the first request transmission-restricting time. If the current generating time T3 doesn't exceed the first request transmission-restricting time, then the client doesn't need to transmit a request to the access server. If the current generating time T3 exceeds the first request transmission-restricting time, then the client transmit the API request to the access server, transfers an If-Modified-Since header, such as If-Modified-Since: Tue, 20 Oct. 2015 18:00:56 GMT to the access server, and inquires whether the API data regarding to the API in the access server updates after the time.

The access server checks the Last-Modified, if it is determined that the data requested by the API hasn't been updated after the previous request, then the access server will directly return the status code HTTP 304 (Not Changed), no content, and such can save the transmission data amount. If it is determined that the data requested by the API has been updated after the previous request, then corresponding data and file are returned.

As shown in FIG. 5B, which is a second schematic diagram of a client for implementing a method for updating client data according to some embodiments of this application, the client is used to perform the method for updating client data according to any of the above-described embodiments, and configured in an intelligent terminal, and the access server for interacting with the client is the one for performing the method for updating client data according to any of the above-described embodiments.

In the client according to this embodiment, the transmission-restricting time acquiring module 510 also can include: an update data acquiring unit 511 and an update operation performing unit 512. Particularly, the update data acquiring unit 511 is configured to acquire update data returned by the access server based on the data update request, and the last data update time of the update data, at the same time of acquiring the request transmission-restricting time returned by the access server based on the data update request; and the update operation performing unit 512 is configured to update local data, based on the update data, and record the last data update time, so as to add the last data update time to the subsequent data update request.

The update request controlling module 520 can include: a request-to-be-transmitted generating unit 523, a time difference calculating unit 524, and a second transmitting state judging unit 525. Particularly, the request-to-be-transmitted generating unit 523 is configured to generate a data update request to be transmitted, and acquire a current generating time of the data update request to be transmitted; the time difference calculating unit 524 is configured to calculate a difference between the current generating time and the last data update time; and the second transmitting state judging unit 525 is configured to judge whether the difference is less than or equal to a time period corresponding to a second request transmission-restricting time, intercept the data update request to be transmitted, if the difference is less than or equal to the time period corresponding to the second request transmission-restricting time, or transmit the data update request to be transmitted to the access server, if the difference is greater than the time period corresponding to the second request transmission-restricting time.

The client in FIG. 5B differs from the client in FIG. 5A in that, the request transmission-restricting time is the second request transmission-restricting time. When the client is ready to transmit the API request at time T3, the client calculates a difference between T3 and the Last-Modified time, and judges whether the difference exceeds the second request transmission-restricting time. If the difference doesn't exceed the second request transmission-restricting time, then the client doesn't need to transmit a request to the access server. If the difference exceeds the second request transmission-restricting time, then the client transmits the API request to the access server and also transfers an If-Modified-Since header.

In this embodiment, the client will make an intelligent judgment based on the request transmission-restricting time returned by the access server, so that the client can control the time for transmitting the data update request to the access server, thereby greatly reducing the burden on the access server and network overhead.

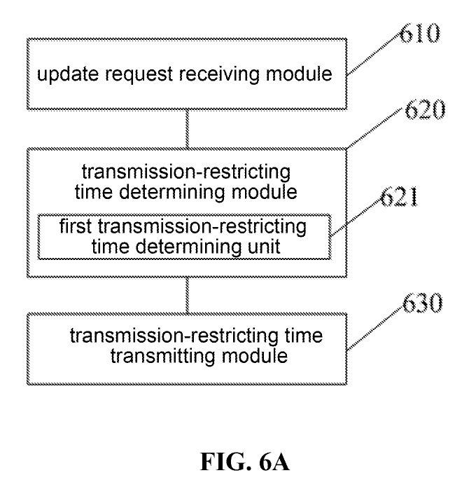

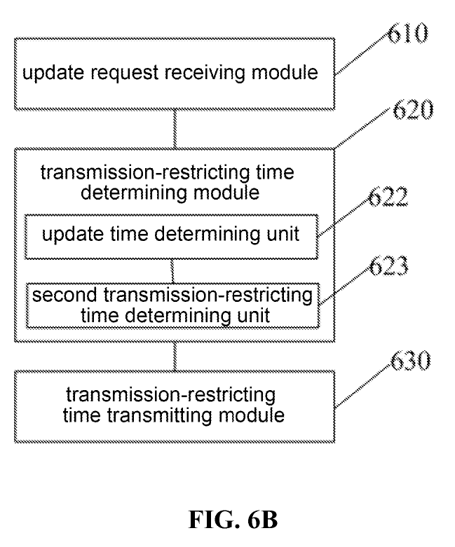

As shown in FIG. 6A, which is a first schematic diagram of a server for implementing a method for updating client data according to some embodiments of this application, technical solutions in this embodiment is applicable to a case that an access server lessens the burden on the access server by setting the transmission-restricting time transmitted to the client. Particularly, the server is the access server for performing the method for updating client data according to any of the above-described embodiments, and the client for interacting with the server is the one for performing the method for updating client data according to any of the above-described embodiments, and configured in an intelligent terminal.

The server for implementing the method for updating client data according to this embodiment includes: an update request receiving module 610, a transmission-restricting time determining module 620, and a transmission-restricting time transmitting module 630. Particularly, the update request receiving module 610 is configured to receive a data update request transmitted by a client; the transmission-restricting time determining module 620 is configured to determine a request transmission-restricting time of the client, based on an update rule of data requested by the data update request; and the transmission-restricting time transmitting module 630 is configured to return the request transmission-restricting time to the client, so that the client can control a consequent time for transmitting the data update request.

Optionally, the transmission-restricting time determining module 620 includes: a first transmission-restricting time determining unit 621. Particularly, the first transmission-restricting time determining unit 621 is configured to determine a next update time for acquiring data to a service server for providing the requested data, based on data requested by the data update request, so as to determine it as a first request transmission-restricting time.

In this embodiment, take the yellow pages application on the intelligent terminal as an example, the client request data to the access server, and the data of the access server is pulled from the service sever, and therefore, it should be clear that the service logic of the access server itself is the update rule. Here, the access server knows the next data update time of the data requested by the client, and then the access server returns the next data update time as the first request transmission-restricting time to the client.

If the server code changes or the server restarts, the server will re-transmit the data, the return process is similar to the process of returning the first request, thus avoiding from transmitting the data repeatedly to the client and guaranteeing that the client data can be updated timely when the server changes.

As shown in FIG. 6B, which is a second schematic diagram of a server for implementing another method for updating client data according to some embodiments of this application. Particularly, the server is the access server for performing the method for updating client data according to any of the above-described embodiments, and the client for interacting with the server is used to perform the method for updating client data according to any of the above-described embodiments, and the client is configured in an intelligent terminal. In the server according to this embodiment, the transmission-restricting time determining module 620 can include: an update time determining unit 622 and a second transmission-restricting time determining unit 623. Particularly, the update time determining unit 622 is configured to determine a next update time for acquiring data to a service server for providing the requested data, based on data requested by the data update request; and the second transmission-restricting time determining unit 623 is configured to determine a second request transmission-restricting time, based on a difference between the next data update time and the last data update time.

The server in FIG. 6B differs from the server in FIG. 6A in that, the request transmission-restricting time is the second request transmission-restricting time. For example, the last data update time for the current data of the access server is 18:30, the next data update time is 18:31, then it can be determined that the access server will not update the current data within the interval of 60 seconds. Therefore, the second request transmission-restricting time returned by the access server to the client is a difference between the next data update time and the last data update time, that is 60 seconds, and the last data update time is also returned. The client controls the time for subsequently transmitting the API request based on the second request transmission-restricting time. Here, the last data update time also can be defined to be the time for returning to the client by the access server.

The seventh embodiment of this application provides a non-volatile computer storage medium having stored thereon computer executable instructions for performing any of the above-described methods for updating client data in this application.

The eighth embodiment of this application provides a non-volatile computer storage medium having stored thereon computer executable instructions for performing any of the above-described methods for updating client data in this application.

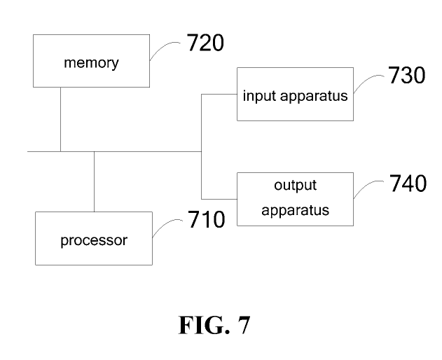

FIG. 7 is a hardware structural schematic diagram of a device for performing the method for updating client data according to some embodiments of this application, as shown in FIG. 7, the device includes:

one or more processors 710 and a memory 720, in FIG. 7, take one processor 710 as an example.

The device also can include: an input apparatus 730 and an output apparatus 740.

The processor 710, the memory 720, the input apparatus 730 and the output apparatus 740 in the device for performing the method for updating client data can be connected via a bus or by other means, in FIG. 7, take connection via a bus as an example.

The memory 720, as a non-volatile computer-readable storage medium, can be used to store a non-volatile software program, a non-volatile computer-executable program and module, such as the program instruction/module corresponding to the method for updating client data according to embodiments of this application (for example, the transmission-restricting time acquiring module 510 and the update request controlling module 520 shown in FIG. 5A). The processor 710 can perform various functional applications and data processing in the server by running the non-volatile software program, instruction and module stored in the memory 720, that is, the method for updating client data according to the above method embodiment can be performed.

The memory 720 can include a storage program area and a storage data area, particularly, the storage program area can store an operating system and an application program required by at least one function; the storage data area can store data created by use of the client for performing the method for updating client data. Besides, the memory 720 can include a high-speed random access memory, and also a non-volatile memory, such as at least one magnetic disk storage device, flash memory device or other non-volatile solid state storage device. In some embodiments, the memory 720 optionally includes memories remotely located from the processor 710, these remote memories can connect to the client for performing the method for updating client data. Examples of the network include, but are not limited to, the Internet, an intranet, a local area network, a mobile communication network and combinations thereof.

The input apparatus 730 can receive the input figure or character information and generate key signal input associated with the user setting and functional control of a client for implementing a method for updating client data. The output apparatus 740 can include a display device, such as a display screen.

One or more modules are stored in the above memory 720, when one or more processors 710 are executed, the method for updating client data according to any of the method embodiments is performed.

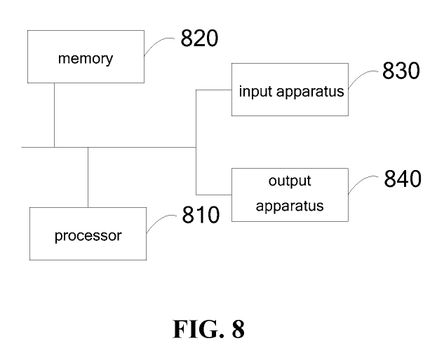

FIG. 8 is a hardware structural schematic diagram of a device for performing the method for updating client data according to some embodiments of this application, as shown in FIG. 8, the device includes:

one or more processors 810 and a memory 820, in FIG. 6, take one processor 810 as an example.

The device also can include: an input apparatus 830 and an output apparatus 840.

The processor 810, the memory 820, the input apparatus 830 and the output apparatus 840 in the device for performing the method for updating client data can be connected via a bus or by other means, in FIG. 8, take connection via a bus as an example.

The memory 820, as a non-volatile computer-readable storage medium, can be used to store a non-volatile software program, a non-volatile computer-executable program and module, such as the program instruction/module corresponding to the method for updating client data according to embodiments of this application (for example, the update request receiving module 610, the transmission-restricting time determining module 620 and the transmission-restricting time transmitting module 630 as shown in FIG. 6A). The processor 810 can perform various functional applications and data processing in a server by running a non-volatile software program, instruction and module stored in the memory 820, that is, to implement the method for processing the list item operation according to the above method embodiment.

The memory 820 can include a storage program area and a storage data area, particularly, the storage program area can store an operating system and an application program required by at least one function; the storage data area can store data created by use of the server for implementing the method for updating client data. Besides, the memory 820 can include a high-speed random access memory, and also a non-volatile memory, such as at least one magnetic disk storage device, flash memory device or other non-volatile solid state storage device. In some embodiments, the memory 820 optionally includes memories remotely located from the processor 810, these remote memories can connect to the server for implementing the method for updating client data through the network. Examples of the network include, but are not limited to, the Internet, an intranet, a local area network, a mobile communication network and combinations thereof.

The input apparatus 830 can receive the input figure or character information and generate key signal input associated with the server and functional control for implementing the method for updating client data. The output apparatus 840 can include a display device, such as a display screen.

One or more modules are stored in the above memory 820, when one or more processors 810 are executed, the method for updating client data according to any of the method embodiments is performed.

The electronic device in embodiments of this application exists in various forms, including but not limited to:

(1) mobile telecommunication device. A device of this kind has a feature of mobile communicating function, and has a main object of providing voice and data communication. Devices of this kind include smart phone (such as IPHONE), multi-media cell phone, functional cell phone, low-end cell phone and the like;

(2) ultra mobile personal computer device. A device of this kind belongs to a category of personal computer, has functions of computing and processing, and generally has a feature of mobile internet access. Devices of this kind include PDA, MID, UMPC devices and the like, such as IPAD;

(3) portable entertainment device. A device of this kind can display and play multi-media content. Devices of this kind include audio and video player (such as IPOD), handheld game player, e-book, intelligent toy and portable vehicle navigation device;

(4) server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) other electronic devices having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating, but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement does not make the corresponding technical solutions depart from the spirit and scope of technical solutions of various embodiments.

What is claimed is:

1. A method for updating client data, comprising:
at an electronic device:
acquiring a request transmission-restricting time returned by an access server based on a data update request; and
controlling a time for subsequently transmitting the data update request to the access server, based on the request transmission-restricting time.

2. The method according to claim 1, wherein, the controlling the time for subsequently transmitting the data update request to the access server, based on the request transmission-restricting time, comprises:
generating a data update request to be transmitted, and acquiring a current generating time of the data update request to be transmitted; and
judging whether the current generating time is less than or equal to a first request transmission-restricting time, intercepting the data update request to be transmitted, if the current generating time is less than or equal to the first request transmission-restricting time, or transmitting the data update request to be transmitted to the access server, if the current generating time is greater than the first request transmission-restricting time.

3. The method according to claim 1, at the same time of acquiring the request transmission-restricting time returned by the access server based on the data update request, the method further comprises:
acquiring update data returned by the access server based on the data update request, and the last data update time of the update data.

4. The method according to claim 3, after acquiring update data returned by the access server based on the data update request, and the last data update time of the update data, the method further comprises: updating local data, based on the update data, and recording the last data update time, so as to add the last data update time to the subsequent data update request.

5. The method according to claim 4, wherein, the controlling the time for subsequently transmitting the data update request to the access server, based on the request transmission-restricting time, comprises:
generating a data update request to be transmitted, and acquiring a current generating time of the data update request to be transmitted;
calculating a difference between the current generating time and the last data update time; and
judging whether the difference is less than or equal to a time period corresponding to a second request transmission-restricting time, intercepting the data update request to be transmitted, if the difference is less than or equal to the time period corresponding to the second request transmission-restricting time, or transmitting the data update request to be transmitted to the access server, if the difference is greater than the time period corresponding to the second request transmission-restricting time.

6. A method for updating client data, comprising:
at an electronic device:
receiving a data update request transmitted by a client;
determining a request transmission-restricting time of the client, based on an update rule of data requested by the data update request; and
returning the request transmission-restricting time to the client, so that the client can control a consequent time for transmitting the data update request.

7. The method according to claim 6, wherein, the determining the request transmission-restricting time of the client, based on the update rule of data requested by the data update request, comprises:
determining a next update time for acquiring data to a service server for providing the requested data, based on data requested by the data update request, so as to determine it as a first request transmission-restricting time.

8. The method according to claim 6, wherein, the determining the request transmission-restricting time of the client, based on the update rule of data requested by the data update request, comprises:
determining a next update time for acquiring data to a service server for providing the requested data, based on data requested by the data update request; and
determining a second request transmission-restricting time, based on a difference between the next data update time and the last data update time.

9. An electronic device, comprising at least one processor and a memory communicably connected with the at least one processor for storing instructions executable by the at least one processor, wherein execution of the instructions by the at least one processor causes the at least one processor to:
acquire a request transmission-restricting time returned by an access server based on a data update request; and
control a time for subsequently transmitting the data update request to the access server, based on the request transmission-restricting time.

10. The electronic device according to claim 9, wherein, when controlling a time for subsequently transmitting the data update request to the access server, based on the request transmission-restricting time, the executable instructions further cause the electronic device to:
generate a data update request to be transmitted, and acquiring a current generating time of the data update request to be transmitted; and
judge whether the current generating time is less than or equal to a first request transmission-restricting time, intercepting the data update request to be transmitted, if the current generating time is less than or equal to the first request transmission-restricting time, or transmitting the data update request to be transmitted to the access server, if the current generating time is greater than the first request transmission-restricting time.

11. The electronic device according to claim 9, wherein, when acquiring a request transmission-restricting time returned by an access server based on a data update request, the executable instructions further cause the electronic device to:
acquire update data returned by the access server based on the data update request, and the last data update time of the update data, at the same time of acquiring the request transmission-restricting time returned by the access server based on the data update request; and
update local data, based on the update data, and record the last data update time, so as to add the last data update time to the subsequent data update request.

12. The electronic device according to claim 11, wherein, when controlling a time for subsequently transmitting the data update request to the access server, based on the request transmission-restricting time, the executable instructions further cause the electronic device to:
generate a data update request to be transmitted, and acquiring a current generating time of the data update request to be transmitted;
calculate a difference between the current generating time and the last data update time; and
judge whether the difference is less than or equal to a time period corresponding to a second request transmission-restricting time, intercept the data update request to be transmitted, if the difference is less than or equal to the time period corresponding to the second request transmission-restricting time, or transmit the data update request to be transmitted to the access server, if the difference is greater than the time period corresponding to the second request transmission-restricting time.
